(19) United States
(12) Patent Application Publication
(10) Pub. No.: US 2010/0114355 A1
(43) Pub. Date: May 6, 2010

(54) METHOD AND SYSTEM FOR MANAGEMENT OF MANUFACTURING INFORMATION

(76) Inventors: Ichiro Harashima, Hitachiohta (JP); Koji Shiroyama, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/611,283

(22) Filed: Nov. 3, 2009

(30) Foreign Application Priority Data
Nov. 4, 2008 (JP) 2008-283666

(51) Int. Cl. G06F 17/00

(52) U.S. Cl. 700/107

(57) ABSTRACT

To allow flexible determination of a manufacturing method, based upon the know-how accumulated at a manufacturing department, and to realize management of adopted manufacturing BOM data. A screen-displayed design BOM is edited by dividing one part into a plurality of subparts or connecting a plurality of parts to one subassembly, depending upon a command entered from an input device, and the edited BOM is stored into a database. At the same time, a link node that represents a part-to-part connection association pertaining to the plural subparts or the subassembly is created and then displayed on the display screen, with data of the link node being stored into the database. The subparts or subassembly connection relationship pertaining to the displayed link node is entered from the input device, then associated to the data of the link node, and stored as attribute data of the link node into another database.

### BACKGROUND OF THE INVENTION

1. Field of the Invention

The present invention relates to a method and system for computer-aided management of manufacturing information on a product including plural kinds of parts.

2. Description of the Related Art

In general, as represented by a product data management (PDM) system, data management during the development and design of a product uses the bill-of-materials information that a computer-aided design (CAD) system has created associating plural kinds of parts with one another in a hierarchical tree form. The bill-of-materials information includes drawings data, shape data, data sheets, and other design documents, for each kind of part.

As proposed in JP-2001-331535-A, for example, such a PDM system is used to create bill-of-materials (BOM) data in a hierarchical tree structure from the BOM information relating to a product which has been associated in a parent-child tree format for the parts designed by three-dimensional CAD, and procure and produce these parts on the basis of the BOM data. In addition, design information on individual parts, included in the BOM data, is managed as the attribute data associated to each part.

Furthermore, as described in JP-2001-331535-A, developing the BOM data from a design phase to the lower-level phases of the procurement and production of the parts requires modifying the hierarchical tree structure. For example, when there is a need to additionally procure any screws, bolts, or other connecting parts left out in the BOM created during the design phase, it is necessary that the initial BOM created during the parts procurement phase should be appropriately edited to accept the additions.

The conventional PDM systems described in documents such as JP-2001-331535-A, however, give practically no consideration to the management of manufacturing methods. For example, in the BOM created during the design phase (this BOM is hereinafter referred to as design-BOM), a subassembly made up of two sub-subparts is handled as one part, and information on how to manufacture and connect plural different kinds of sub-subparts is only defined by specifying connection strength and other parameters in terms of attribute information. There is another problem in that since the determination of further detailed manufacturing methods are usually based upon manufacturing specialists' know-how, the PDM system cannot manage the BOM data created during a manufacturing phase (this BOM data is referred to as manufacturing BOM data).

In connection with the above, JP-1997-267239-A proposes a method in which the design BOM data and manufacturing BOM data relating to the design and manufacture, respectively, of a product and parts, are associated with each other as different classes of object models and thus managed in an integrated and unwasteful manner. In the method proposed in JP-1997-267239-A, a PDM system can manage manufacturing BOM data to some extent.

### SUMMARY OF THE INVENTION

However, it is difficult to provide for the manufacturing BOM data deterministically during the design phase, as in JP-1997-267239-A, since the data is required to be determined in combination between BOM information and various other manufacturing-related information on processes and costs.

To manage the manufacturing information relating to the product, therefore, it is requested to establish a data structure not depending upon a manufacturing method, and a mechanism or architecture flexibly responsive to any changes in manufacturing-BOM data structure during manufacturing processes such as processing and assembly. To realize the management of manufacturing information on assembly and welding operations, for example, it is desired that an information management method that allows flexible follow-up of any changes in unit of objects to be processed should be established.

Objects of the present invention are to enable flexible determination of a manufacturing method, based upon manufacturing staff's specialistic know-how, and to realize management of adopted manufacturing BOM data.

In order to solve the foregoing problems, the present invention provides, as one aspect thereof, a manufacturing information management method implemented using a computer, the method being a product-manufacturing information management method for managing product-manufacturing information by creating product-manufacturing BOM data during a manufacturing phase, based upon design BOM data created during a design phase by a CAD system. More specifically, the manufacturing information management method for managing the product-manufacturing information by creating the product-manufacturing BOM data during the manufacturing phase, based upon the design BOM data created during the design phase by the CAD system, includes: a first step in which a design BOM of a hierarchical tree structure is displayed as an image on a display screen; a second step in which the design BOM displayed in the first step is edited by dividing one part into a plurality of subparts or connecting a plurality of parts to one subassembly, depending upon a command entered for the displayed design BOM from input means, then storing the edited design BOM into a database; a third step in which a link node that represents part-to-part connection association pertaining to the subparts or subassembly obtained from the division or connection in the second step is created, then the link node is displayed in association with the design BOM on the display screen, and data of the link node is stored into the database; a fourth step in which the subparts or subassembly connection relationships that pertain to the link node displayed in the third step are entered as attribute data of the link node from the input means; and a fifth step in which the attribute data entered in the fourth step is bound to the link node and then stored into the database.

In this way, a more specific manufacturing method relating to processing or assembly can be determined or changed on the basis of manufacturing staff's specialistic know-how by editing the screen-displayed design BOM in the form of dividing one part into a plurality of subparts or connecting a plurality of parts to one subassembly, and then entering from input means a subpart or subassembly connecting method as attribute data of the link node representing the part-to-part connection association pertaining to the subparts or subassembly obtained from the above division or connection, respectively.

For example, if a part having a shape with a cylindrical boss positioned upright on a plate-like member is defined in a design BOM, various manufacturing methods are available, such as connecting the boss to the plate-like member by welding, connecting both by screwing, or connecting both by press-fitting. In such an example, provided that the connecting strength defined in the design BOM is satisfied, it is preferable that various information, including the number of processes and cost involved with a manufacturing method for that part, should be combined and the manufacturing method determined or changed on the basis of manufacturing staff's specialistic know-how.

In this respect, according to the present invention, when a specialist from a manufacturing department judges it to be desirable that one part be divided into a plate-like member and a boss and then both connected by welding, a manufacturing BOM data structure that is a changed version of a design and manufacturing BOM data structure is formed and manufacturing information concerning the particular manufacturing method is bound as attribute data to the manufacturing BOM data.

That is to say, a mechanism or architecture flexibly responsive to any changes in manufacturing BOM structure is established and design BOM data of a structure not depending upon the manufacturing method, and manufacturing BOM data are managed using a PDM system. In other words, management of the processing- or assembly-related manufacturing information traditionally excluded from management is implemented since the manufacturing method is determined flexibly on the basis of manufacturing staff's specialistic know-how and since any changes in unit of objects to be processed are flexibly accommodated.

In addition, there is added a sixth step in which, in response to an access request entered from the input means, the database containing the attribute data of the link node is searched for and manufacturing BOM data based upon the design BOM that was edited in the second step, the third step, and the fifth step, is created and output. The manufacturing information management system according to the present invention is further adapted to output the manufacturing BOM data to another user computer in accordance with a request entered via a communications network. In this case, the manufacturing BOM data is output in a hierarchical tree format on a display screen of the user computer in accordance with the request, and when the user specifies the displayed part, subparts, or subassembly, the attribute data of the link node will, before being presented to the user, be incorporated into entity data such as computer-processable characters, images, graphics, or shapes.

Another product-manufacturing information management system according to the present invention uses a computer to manage manufacturing information by creating manufacturing BOM data based upon design BOM data created by a CAD system, the computer including an arithmetic processing unit, input means, image display means, and a storage unit.

More specifically, the arithmetic processing unit is driven in accordance with a program stored into the storage unit beforehand, and includes: design BOM data acquisition means that acquires the design BOM data from the CAD system and then stores the acquired data into the storage unit; parts dividing/connecting means that reads out the stored design BOM data from the storage unit, then displays this BOM data in an image format on a screen of the image display means, and after editing the displayed design BOM data by dividing one part into a plurality of subparts or connecting a plurality of parts to one subassembly, depending upon a command entered for the displayed design BOM data from the input means, stores the edited design BOM data into the storage unit, the parts dividing/connecting means being further adapted to create a link node that represents part-to-part connection association pertaining to the subparts or subassembly obtained from the above division or connection, display the link node, in association with the design BOM data, on the screen of the image display means, and store data of the link node into the storage unit; and attribute data input and management means that binds attribute data entered from the input means in order to define connection relationships of the subparts or the subassembly, to the link node displayed on the screen of the image display means, and stores the attribute data into the storage unit.

In this case, the arithmetic processing unit is further adapted to include attribute data search and output means that searches for the attribute data in the storage unit in response to an access request entered from the input means, and then creates and outputs the manufacturing BOM data based upon the design BOM data edited by the parts dividing/connecting means and the attribute data input and management means.

Furthermore, in response to another access request, the attribute data search and output means creates part IDs or names, data of the link node, and inquiry data relating to the attribute data, then after searching from storage unit for any entity data matching or resembling the inquiry data, presents results of the search, and outputs the data of the link node, the attribute data, and the parts associated with the entity data, to the screen of the image display means.

According to the present invention, a manufacturing method can be determined flexibly on the basis of manufacturing staff's specialistic know-how, and adopted manufacturing BOM data can be managed appropriately.

### BRIEF DESCRIPTION OF THE DRAWINGS

FIG. 1 is a block diagram illustrating a first embodiment of a manufacturing information management system in the present invention;

FIG. 2 shows an example of an edit menu for creating a manufacturing BOM from a design BOM;

FIG. 3 shows an example of an edit menu for adding attribute data to part-to-part connection relationships;

FIG. 4 is a flow diagram showing an example of a process flow in a design BOM data acquisition function, parts dividing/connecting function, and an attribute data input and management function;

FIG. 5 is a flow diagram showing an example of a process flow for searching for attribute data of created manufacturing BOM data and transferring the attribute data to the attribute data search and output function 17;

FIG. 6 is a flow diagram showing another example of a process flow in the parts dividing/connecting function and the attribute data input and management function;

FIG. 7 is a flow diagram showing yet another example of a process flow in the parts dividing/connecting function and the attribute data input and management function; and

FIG. 8 is a total system block diagram of a second embodiment of the present invention, this block diagram showing the embodiment in which a plurality of users share the manufacturing information management system of the invention via a communications network.

### DESCRIPTION OF THE PREFERRED EMBODIMENTS

Hereunder, embodiments of a manufacturing information management system for implementing a manufacturing information management method according to the present invention will be described.

### First Embodiment

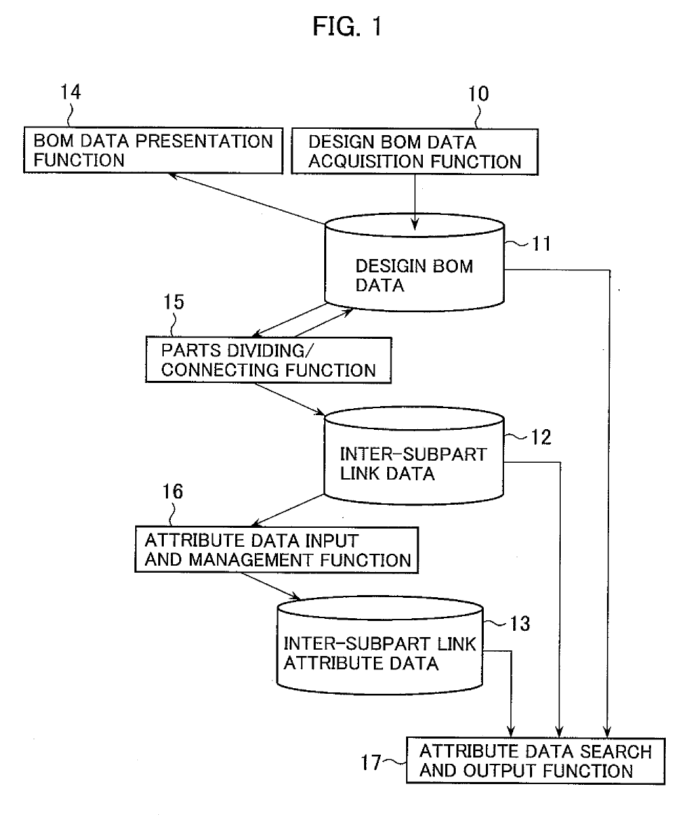

FIG. 1 is a block diagram illustrating a first embodiment of the manufacturing information management system. In FIG. 1, which is a block diagram that illustrates element functions of the manufacturing information management system in the present embodiment and a flow of data, these element functions are implemented by a general-purpose computer including an arithmetic processing unit, a storage unit, an input unit, a display unit, and a communications unit, and by a memory that is a storage medium in which a program readable by the computer is stored to implement the manufacturing information management method.

Referring to FIG. 1, a design BOM data acquisition function 10 is implemented by the arithmetic processing unit operated by the program, and acquires BOM (bill of materials) data that represents materials required for assembly of parts, from a computer-aided design (CAD) system for product design support, or from a product data management (PDM) system for product information management, neither of the two systems being shown in the figure. The BOM data has a hierarchical tree structure based upon parental relationships between parent parts and child parts. The BOM created during a product design phase is hereinafter termed “design BOM”.

The design BOM data that the design BOM data acquisition function 10 has acquired is stored into a database 11 constructed by the storage unit. One line in the most common table structure for representing the design BOM data in the database 11 is expressed by:
Parent part ID (or name)
Child part ID (or name)

A BOM data presentation function 14 is also implemented by the arithmetic processing unit operated by the program. The data presentation function 14 reads out the design BOM data from the database 11 and displays the BOM data in a hierarchical tree format, for example, on a display screen of the computer.

A parts dividing/connecting function 15 is also implemented by the arithmetic processing unit operated by the program. The parts dividing/connecting function 15 edits the above-displayed design BOM data of the hierarchical tree format by dividing one part into a plurality of subparts or connecting a plurality of parts to one subassembly, depending upon a command entered from an input element not shown. The parts dividing function divides a part of the lowest level in the design BOM tree that represents a minimum part unit, into subparts that are even smaller parts. Conversely to the parts dividing function, the part connecting function connects a plurality of parts within the design BOM tree to form one subassembly.

The design BOM data that has been edited by the parts dividing/connecting function 15 is stored into the database 11. In addition, the parts dividing/connecting function 15 creates a link node that represents part-to-part connection association pertaining to the subparts or subassembly obtained from the above division or connection, and stores the link node into the database 11. The parts dividing/connecting function 15 further displays the link node on the display screen in association with the design BOM tree.

Furthermore, the parts dividing/connecting function 15 stores link data pertaining to the link node displayed on the display screen, into a database 12. One line in the most common table structure for representing the link data in the database 12 here is expressed by:
Subpart ID (or name)
Subpart ID (or name)
Link data ID (or name)

The parts dividing/connecting function 15 described above allows a user at a manufacturing department to freely determine or change a bill of materials, based upon the design BOM, and create an optimal manufacturing BOM.

An attribute data input and management function 16 is also implemented by the arithmetic processing unit operated by the program. A subpart or subassembly connecting method for the screen-displayed link node, entered from the input device, is stored as link attribute data into a database 13 by the attribute data input and management function 16, in which the stored data is then managed. The attribute data here can be of any data format that the computer can handle. One line in the most common table structure for representing the attribute data of the link node in the database 13 is expressed by:
Link data ID (or name)
Attribute data ID (or name, or a name including location position of the data)

An attribute data search and output function 17 is also implemented by the arithmetic processing unit operated by the program. In accordance with an access request entered from the input device, the attribute data search and output function 17 creates a part ID (or name) and a request command in the same kind of data format as that of the attribute data stored in the database 13. In accordance with the entered access request, the attribute data search and output function 17 also searches the database 13 for any attribute data that satisfies conditions, and outputs the data (if present).

For example, if a part is designated in the access request entered from the input device, the attribute data search and output function 17 searches for any attribute data assigned to that part. If attribute data containing a specific word(s) is designated in the access request, the attribute data search and output function 17 searches for all attribute data containing the word(s). If a specific image or graphics is designated in the access request, the attribute data search and output function 17 searches for all attribute data whose shape is the same as or resembles that of the designated image or graphics.

Hereunder, operations and process flows that relate to the parts dividing/connecting function 15 and attribute data input and management function 16 featuring the present invention will be described in further detail.

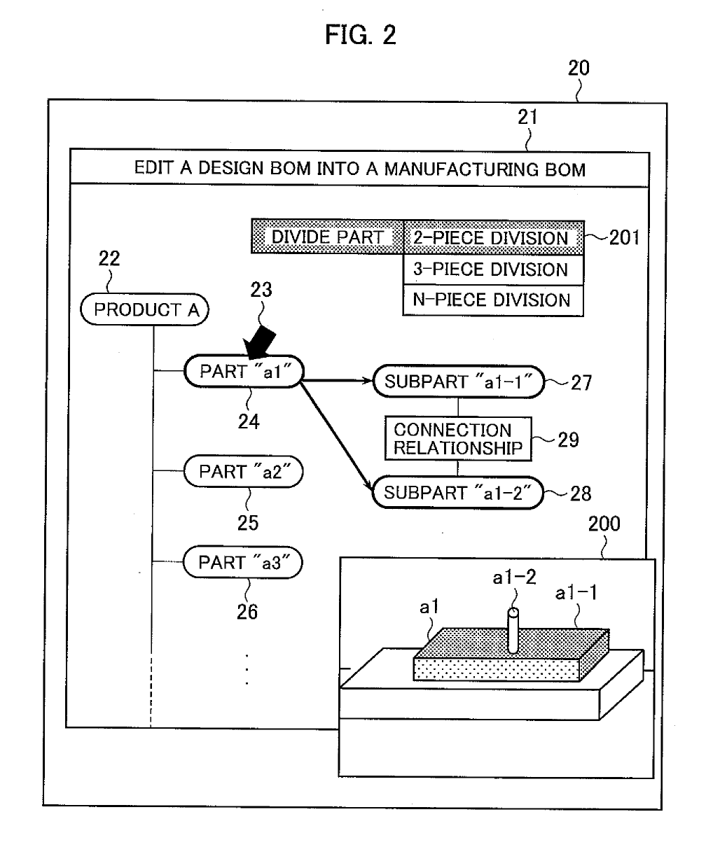

The operations and process flow relating to the parts dividing/connecting function 15 are first detailed below referring to FIG. 2 that shows an example of an edit menu for creating a manufacturing BOM from a design BOM. Of part nodes 24, 25, 26, etc. that are listed as parts of the lowest level in a BOM tree 22 shown in FIG. 2 to represent a part hierarchy of a product A displayed on a display screen 20, the part node 24 denoted as “Part a1” to be divided is selected using a pointing device, such as a mouse, that is the input device. Next, “Divide Part” is selected from an execution command select window 201 displayed as a pop-up window, for example, on the menu. Thus, an area for designating a parts dividing method is added to the execution command select window 201, and a dividing method that matches conditions is selected as a candidate from the command select window. “2-piece division” is selected in the example of FIG. 2. If “N-piece division” is selected instead, an area for entering a desired number of pieces into which the part is to be divided is added to the right of the execution command select window 201.

After that, the part node 24 denoted as “Part a1” is divided into the designated number of subparts. In the example of FIG. 2, the part is divided into two pieces, namely, “Subpart a1-1” and “Subpart a1-2”, and division indicator arrow-marked lines and part nodes 27 and 28 are additionally displayed. At this time, a link node 29 representing a “Connection relationship” of the two subparts is created between the part nodes 27 and 28. In the example of FIG. 2, the connection relationship is represented using a line segment that connects the link node 29 and the part nodes 27 and 28.

In addition to the edit area 21 for operating the design BOM tree shown in FIG. 2, a three-dimensional (3-D) part shape of the product A is displayed in a 3-D shape display area 200. In this case, a spatial state and location of the part node being edited can be recognized and confirmed by, for example, changing a display color of the 3-D shape of the part.

As described per FIG. 1, the 3-D part shape displayed in the 3-D shape display area 200 is acquired from the CAD system by the design BOM data acquisition function 10 and stored into the database 11. During an initial phase of editing, therefore, the part node in the design BOM data is associated with the 3-D part shape at a rate of 1:1, but repetition of parts dividing/connecting operations on the BOM data will disturb the association rate of 1:1. If this happens, performing an operation such as changing a display color of a 3-D part shape appropriate for a parent part node of the corresponding part node or blinking the 3-D part shape will create a representation indicating that the 3-D part shape is not associated with the part node at the rate of 1:1. Additionally, to make more intuitive recognition possible, division lines, comments, and functions for reference may be added to the corresponding 3-D part shape in the 3-D shape display area 200.

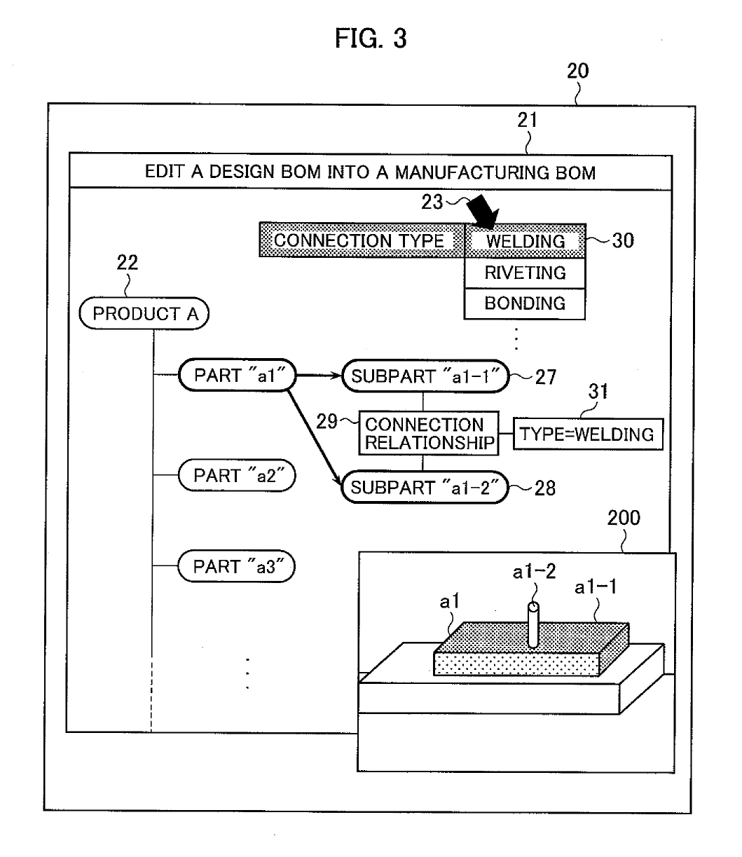

Next, the operations and process flow relating to the attribute data input and management function 16 are detailed below referring to FIG. 3 that shows an example of an edit menu for creating a manufacturing BOM from a design BOM. In the example of FIG. 3, the attribute data input and management function 16 adds attribute data to a connection relationship of two subparts, “a1-1” and “a1-2”, into which one part “a1” was divided.

In FIG. 3, a link node 29 in a connection relationship is selected using the pointing device such as a mouse, and then a “Connection type” is selected from an execution command select window 30 such as a pop-up window. Thus, an area for designating a connection type is additionally displayed in the execution command select window 30. A connection type suitable for use as viewed from a standpoint of a specialist in manufacturing is selected from all displayed connection types. The example in FIG. 3 indicates that “Welding”, “Riveting”, “Bonding”, and the like are listed as the useable connection types, and that “Welding” is selected from the list of candidates. In this case, when welding conditions and other parameters are to be designated, an area for entering the welding conditions and other parameters is further added to the right of the window. For example, a welding method, welding equipment, the number of sections to be welded, the kind of welding material such as a welding rod, and the like are to be designated as the welding conditions.

In addition, when a new selection item is to be added, “Add new item” is created in the execution command select window 30. The new selection item is selected and along with an item name of the new selection item, at least one item name of any options useable after the selection has been performed is entered and registered. For example, “TIG welding”, “MIG welding”, etc. are registered as selected option item names in list form following a selection item name of “Welding type”. Thus, an end user can freely add attribute data items when using this system.

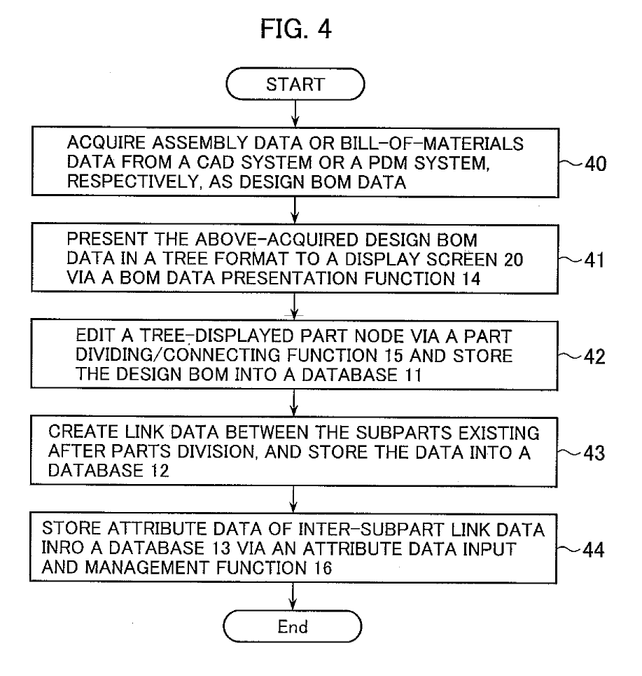

FIG. 4 shows an example of a process flow for creating the above-described manufacturing BOM data, link node data, and link node attribute data, via the design BOM data acquisition function 10, parts dividing/connecting function 15, and attribute data input and management function 16 shown in FIG. 1.

### (Step 40)

In step 40, assembly data or bill-of-materials data is acquired as design BOM data from the CAD system or the PDM system, respectively, by the design BOM data acquisition function 10, and stored into the database 11.

### (Step 41)

In step 41, the design BUM data that was acquired in step 40 is transferred from the BOM data presentation function 14 to the BOM edit area 21 of the display screen 20, in a hierarchical tree format with parts listed as nodes.

### (Step 42)

In step 42, one of the part nodes which were displayed in the hierarchical tree format in step 41 is edited using the parts dividing/connecting function 15, and then the edited design BOM is stored into the database 11.

### (Step 43)

In step 43, a link node 29 is created between the subparts existing after division of the part in step 42 by the parts dividing/connecting function 15, and data of the link node 29 is stored into the database 12.

### (Step 44)

In step 44, the attribute data 31 of the link node 29 that was entered in step 43 using the attribute data input and management function 16 is stored into the database 13.

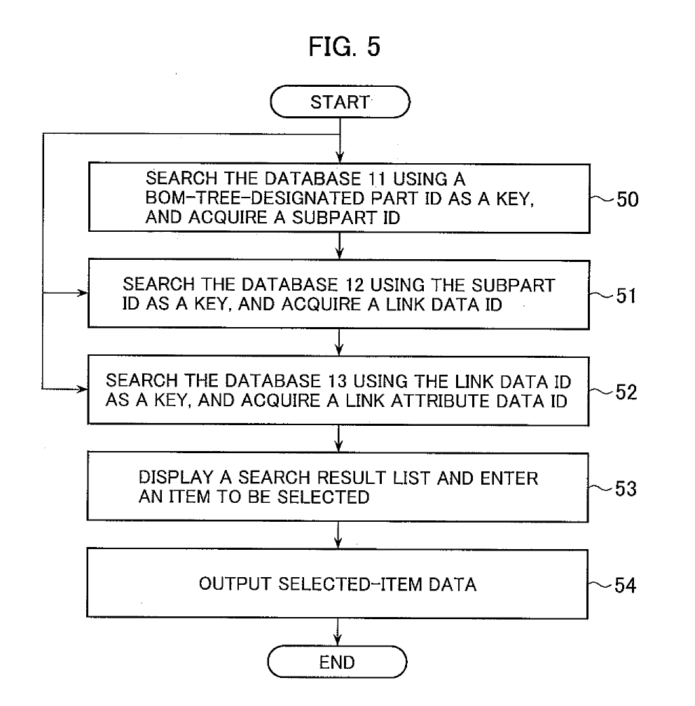

FIG. 5 shows an example of a process flow for searching for attribute data in created manufacturing BOM data and transferring the attribute data to the attribute data search and output function 17.

### (Step 50)

In step 50, a desired part node in the design BOM tree displayed on the display screen is searched for from the database 11. The part ID (or name) designated with the pointing device (e.g., a mouse) is used as a key of the search. After the search, the appropriate subpart ID (or name) that is the minimum part unit is acquired.

### (Step 51)

In step 51, the database 12 is searched for with the above-acquired subpart ID (or name) as a key, and a link data ID (or name) of the link node is acquired.

### (Step 52)

In step 52, the database 13 is searched for with the above-acquired link data ID (or name) as a key, and a link attribute data ID (or name) is acquired.

### (Step 53)

In step 53, results of the above searches are listed on the display screen and a necessary item is selected from the list.

### (Step 54)

In step 54, data of the item which was selected in step 53 is displayed on the screen.

As described above, in the present embodiment, a design BOM of the hierarchical tree format is displayed as an image on the display screen 20 first. Next, the displayed design BOM is edited by dividing one part “a1” into a plurality of subparts “a1-1”, “a1-2”, in response to a command entered from the input device such as the pointing device. After that, the link node 29 representing the connection relationship of the plural subparts “a1-1”, “a1-2”, is displayed in association with the design BOM on the display screen 20. A method of interconnecting the subparts “a1-1”, “a1-2” pertaining to the displayed link node 29 is entered as the attribute data thereof from the input device, and the entered attribute data is bound to the link node 29 and stored into the appropriate database. Thus, a manufacturing BOM of the hierarchical tree format can be created and manufacturing BOM data based upon the manufacturing BOM can be generated.

According to the present embodiment, during the manufacturing phase, manufacturing BOM data based upon the design BOM data generated during the design phase by a CAD system can be created to manage manufacturing information. In particular, a manufacturing method pertaining to the subparts or subassembly obtained from parts division or connection can be entered from the input device as the attribute data of the link node representing the part-to-part connection association relating to the subparts or the subassembly. A more specific manufacturing method relating to part processing or assembly, therefore, can be determined or changed on the basis of manufacturing staff's specialistic know-how.

For example, if a part having a shape with a cylindrical boss positioned upright on a plate-like member is defined in a design BOM as shown in the example of FIG. 2, various manufacturing methods are available, such as connecting the boss to the plate-like member by welding, connecting both by screwing, or connecting both by press-fitting. In such an example, provided that the connecting strength defined in the design BOM is satisfied, the manufacturing method can be determined or changed on the basis of manufacturing staff's specialistic know-how by combining various information such as the number of processes and cost involved with the manufacture of that part.

For example, if a specialist involved in the manufacturing department judges it desirable that one part be divided into a plate-like member and a boss and then both be interconnected by welding, a manufacturing BOM of a structure different from that of a design and manufacturing BOM can be created and manufacturing information on the manufacturing method can be bound as attribute data to the manufacturing BOM data.

An example of editing a design BOM by dividing one part into a plurality of subparts and then establishing the connection relationship of the subparts has been shown in the relevant figures. However, the present invention is not limited to the example. A design BOM can be edited by, conversely to the above division, connecting a plurality of parts to one subassembly. In this case, a design BOM of the hierarchical tree format is displayed as an image on the display screen 20, and then the design BOM is edited by connecting a plurality of parts to one subassembly in response to a command entered from the input device such as the pointing device. Next, the link node 29 representing the connection relationship of the subassembly is displayed in association with the design BOM on the display screen 20, and the connecting method pertaining to the subassembly of the displayed link node 29 is entered as the attribute data thereof from the input device such as the pointing device. The entered attribute data is then bound to the link node 29, so that a manufacturing BOM of the hierarchical tree format can be created. The created manufacturing BOM will be stored as manufacturing BOM data in distributed form into the databases 11, 12, and 13.

According to the present embodiment, therefore, a mechanism or architecture flexibly responsive to any changes in manufacturing BOM structure can be established. In addition, design BOM data of a structure not depending upon any specific manufacturing methods, and manufacturing BOM data can be managed using a PDM system. In other words, management of the processing- or assembly-related manufacturing information traditionally excluded from management is implemented since a manufacturing method can be determined flexibly on the basis of manufacturing staff's specialistic know-how and since any changes in the unit of processing objects or the like can be flexibly followed.

Additionally, according to the present embodiment, the manufacturing BOM data stored within the databases 11, 12, and 13 can be output to another user computer in response to a request entered via a communications network. In this case, the manufacturing BOM of the hierarchical tree format is displayed on the display screen of the user computer in accordance with the request, and when the user specifies the displayed part, subparts, or subassembly, the attribute data of the link node will, before being presented to the user, be incorporated into entity data such as computer-processable characters, images, graphics, or shapes.

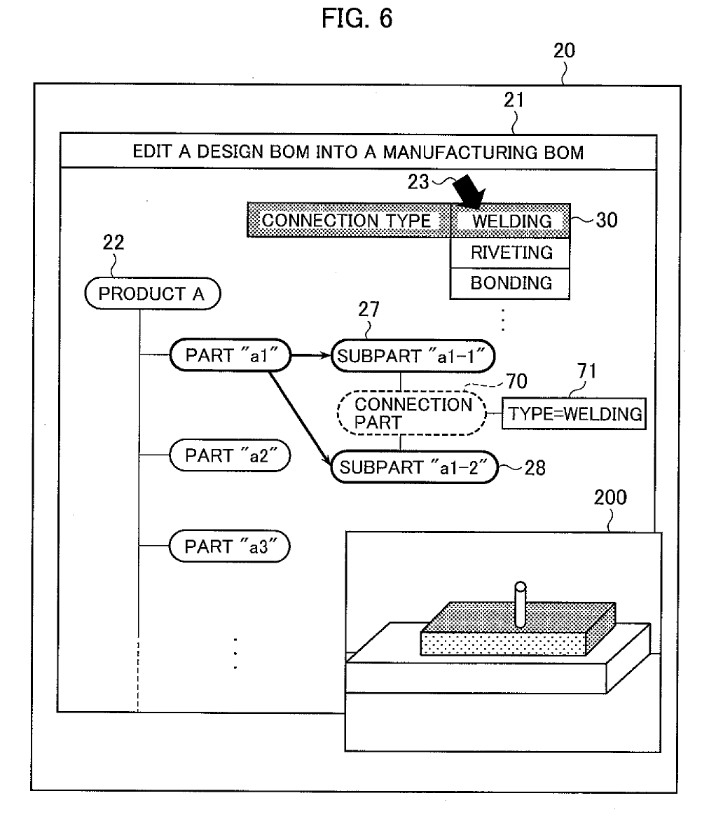

An example of dividing one part “a1” into a plurality of subparts “a1-1”, “a1-2” and then establishing the connection relationship (connecting method) of these subparts as the attribute data 31 of the link node 29 has been shown in FIGS. 2 and 3. However, the present invention is not limited to the example; as shown in FIG. 6, definition may use a virtual connection part node 70 instead of the link node 29, and a connection relationship of the connection part node 70 may be defined as attribute data 71.

FIG. 6 shows an example in which, as in the example of FIG. 3, the connection part node 70 on the screen is selected using the pointing device such as a mouse, and then a connection type for the connection part node 70 is selected from the execution command select window 30 such as a pop-up window. Thus, a connection type select area is additionally displayed on the execution command select window 30. A person-in-charge of the manufacturing department selects a connection type that matches design BOM data requirements such as strength, from displayed candidates. “Welding” is selected in the example of FIG. 6. In this case, when welding conditions and/or other parameters are to be entered, an area for entering the welding conditions and other parameters is additionally displayed on the execution command select window 30.

In addition, in the example of FIG. 6, as in FIGS. 2 and 3, when a new selection item is to be added, “Add new item” is created in the execution command select window 30. The new selection item is selected and along with an item name of the new selection item, at least one item name of any options useable after the selection has been performed is entered and registered. For example, “TIG welding”, “MIG welding”, etc. are registered as selected options in list form following a selection item name of “Welding type”. Thus, the end user can freely add attribute data items when using this system.

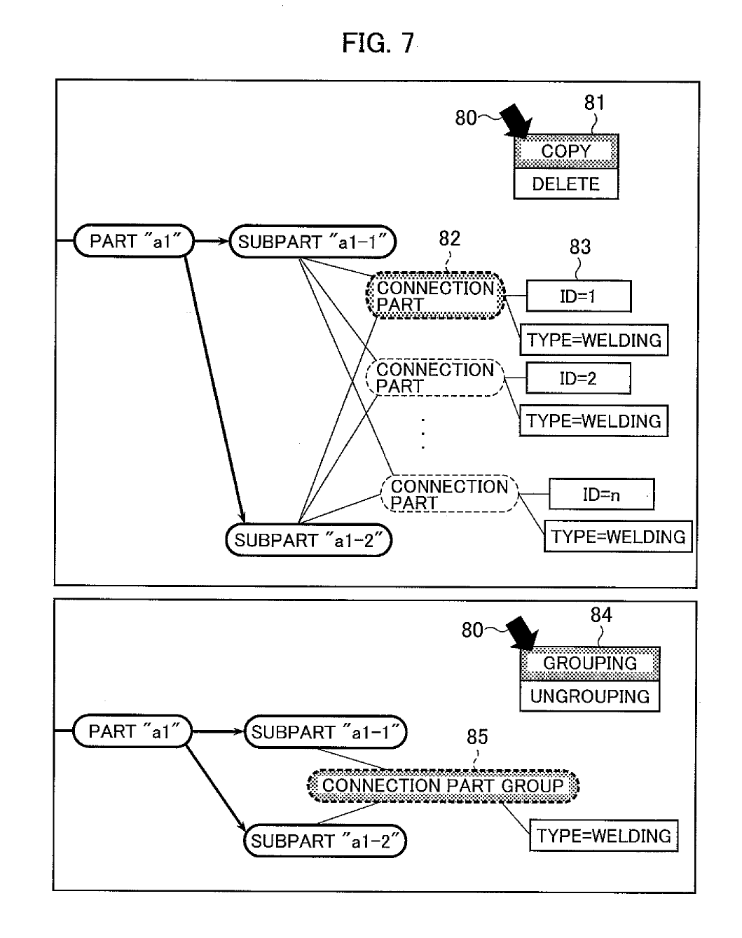

Furthermore, the link node or connection parts of the subparts “a1-1” and “a1-2” which were edited in FIG. 2, 3, or 6, can be grouped, as in the edit menu of FIG. 7. That is to say, as shown in an upper diagram of FIG. 7, a connection part node 82 is selected using the pointing device such as a mouse. Next, a “Copy” command” is selected from an execution command select window 80 such as a pop-up window. Thus, copies of the connection part node 82 are created and displayed.

Next, as shown in a lower diagram of FIG. 7, the copies of the connection part node 82 are each selected using the pointing device such as a mouse, and a “Grouping” command is selected from the execution command select window 80 such as a pop-up window. Thus, the selected connection part nodes 82 are grouped and then displayed as one connection part group node 85. After this, attribute data on a connecting method can be added to the connection part group node 85 in a manner similar to adding attribute data to a single part connection node 82.

### Second Embodiment

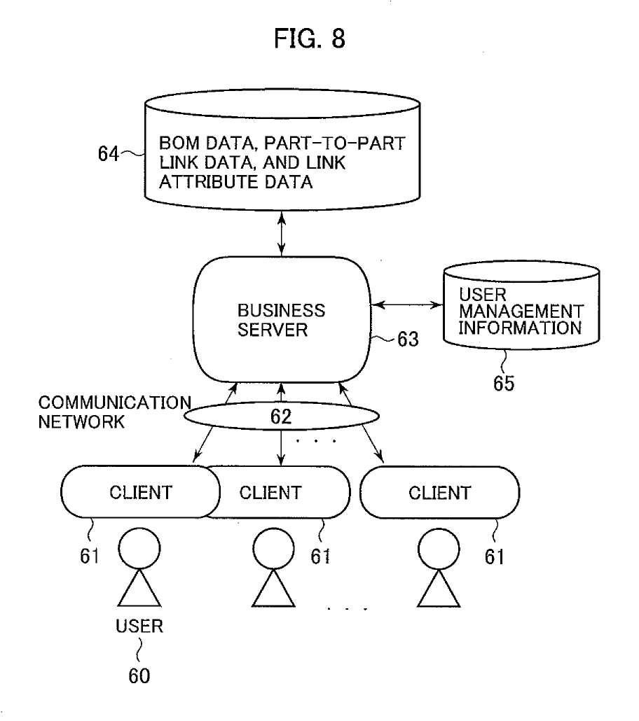

FIG. 8 shows a total system block diagram of another embodiment of the present invention. This total system block diagram shows the embodiment in which the manufacturing information management system described per FIG. 1 allows a plurality of users to manage product design and manufacturing data via a communications network.

Each user 60 at design, manufacturing, and procurement departments, shown in FIG. 8, can use a search client 61 to access a business server 63 of the manufacturing information management system of FIG. 1 via a communications network 62 and exchange desired data with the server 63. A database 65 that contains user management information, and a database 64 including the databases 11, 12, and 13 of the manufacturing information management system of FIG. 1 are connected to the business server 63. Design BOM data, link data of a link node, and link attribute data are stored within the database 64.

In the present embodiment, the business server 63, by processing data in coordination with the database 64, executes access control, BOM data editing, registration, search, and other programs, in response to a request of the user 60, and presents execution results to the user 60. At this time, the business server 63 prevents internal data mismatching of the database 64 by conducting data management based upon exclusive control responsive to an access right and operations defined in the user management information of the database 65.

As described above, according to the embodiments of the present invention, an information management system can be constructed that is less dependent upon part-processing and assembly methods, as during the manufacture of a product, and more flexibly responsive to changes in list of manufacturing BOM data or manufacturing information items, than conventional PDM systems. In addition, the end user can reduce workloads of data constructing and maintenance. Furthermore, the end user can improve product quality and reduce manufacturing periods by searching for and reusing knowledge on manufacture.

What is claimed is:

1. A manufacturing information management method for managing product-manufacturing information by creating product-manufacturing BOM data based upon design BOM data created by a CAD system, the management method comprising:
a first step in which a design BOM of a hierarchical tree format is displayed as an image on a display screen;
a second step in which the design BOM displayed in the first step is edited by dividing one part into a plurality of subparts or connecting a plurality of parts to one subassembly, depending upon a command entered for the displayed design BOM from input means, then storing the edited design BOM into a database;
a third step in which a link node that represents part-to-part connection association pertaining to the subparts or subassembly obtained from the division or connection in the second step is created, then the link node is displayed in association with the design BOM on the display screen, and data of the link node is stored into the database;
a fourth step in which the subparts or subassembly connection relationships that pertain to the link node displayed in the third step are entered as attribute data of the link node from the input means; and
a fifth step in which the attribute data entered in the fourth step is bound to the link node and stored into the database.

2. The manufacturing information management method according to claim 1, further comprising:
a sixth step in which, in response to an access request entered from the input means, the database is searched for and manufacturing BOM data based upon the design BOM that was edited in the second step, the third step, and the fifth step, is created and output.

3. The manufacturing information management method according to claim 2,
wherein: in the second, third, and fifth steps, prior to storage into the database, the edited design BOM data, the data of the link node, and the attribute data of the link node are each registered in the database, either as general drawings, shape models, computer-processable characters, images, graphics, shapes, or other entity data, or with an assigned storage address of the entity data; and
in the sixth step, in response to the access request, a part ID or name, data of the link node, and inquiry data on the attribute data are created, then after a search of the database for any entity data matching or resembling the inquiry data, results of the search are presented, and the part associated with the entity data, the data of the link node, and the attribute data are displayed on the display screen.

4. The manufacturing information management method according to claim 1,
wherein the attribute data includes information on factors other than parts of a product, as well as on connection methods and procedures and on manufacturing equipment.

5. A manufacturing information management system that uses a computer to manage manufacturing information by creating manufacturing BOM data based upon design BOM data created by a CAD system, the computer including an arithmetic processing unit, input part, image display part, and a storage unit,
wherein the arithmetic processing unit is driven in accordance with a program stored in the storage unit beforehand, the arithmetic processing unit further includes:
design BOM data acquisition part that acquires the design BOM data from the CAD system and then stores the acquired data into the storage unit,
parts dividing/connecting part that reads out the stored design BOM data from the storage unit, then displays the BOM data in an image format on a screen of the image display part, and after editing the displayed design BOM data by dividing one part into a plurality of subparts or connecting a plurality of parts to one subassembly, depending upon a command entered from the input part, stores the edited design BOM data into the storage unit, the parts dividing/connecting part being further adapted to create a link node that represents a part-to-part connection association pertaining to the subparts or subassembly obtained from the division or the connection, respectively, display the link node, in association with the design BOM data, on the screen of the image display part, and store data of the link node into the storage unit, and
attribute data input and management part that associates attribute data entered from the input part in order to define connection relationships of the subparts or the subassembly, to the link node displayed on the screen of the image display part, and stores the attribute data into the storage unit.

6. The manufacturing information management system according to claim 5,
wherein the arithmetic processing unit further includes attribute data search and output part that searches for the attribute data in the storage unit in response to an access request entered from the input part, and then creates and outputs the manufacturing BOM data based upon the design BOM data edited by the parts dividing/connecting part and the attribute data input and management part.

7. The manufacturing information management system according to claim 6,
wherein in response to the access request, the attribute data search and output part creates part IDs or names, data of the link node, and inquiry data relating to the attribute data, then after searching from storage unit for any entity data matching or resembling the inquiry data, presents results of the search, and outputs the data of the link node, the attribute data, and the parts associated with the entity data, to the screen of the image display part.

8. The manufacturing information management system according to claim 7,
wherein the arithmetic processing unit has user management information for access management of plural user terminals connected via a communications network; and
the attribute data search and output part includes control part for inhibiting simultaneous division into and connection to identical parts when access is requested from the user terminals, and control part for inhibiting simultaneous edit operations upon connection information of the same name.
